(19) United States
(12) Patent Application Publication
(10) Pub. No.: US 2007/0200870 A1
(43) Pub. Date: Aug. 30, 2007

(54) Home appliance with electronic album function

(75) Inventors: Seong Hae Jeong, Changwon-si (KR); Soung Bong Choi, Changwon-si (KR); Deug Hee Lee, Gimhae-si (KR); Byung Hwan Ahn, Gimhae-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 11/478,355

(22) Filed: Jun. 30, 2006

(30) Foreign Application Priority Data
Jun. 30, 2005 (KR) 10-2005-57661
Jun. 30, 2005 (KR) 10-2005-57663

(51) Int. Cl. G09G 5/00

(52) U.S. Cl. 345/619

(57) ABSTRACT

Disclosed herein is a home appliance with an electronic album function which is capable of electronically constructing and displaying an album. The home appliance includes a washing device for washing or drying clothes, and a monitor device fixedly mounted in a predetermined position of the washing device or detachably mounted thereto. The monitor device stores image data including photographs and moving images and displays the stored image data in response to a request from a user.

This application claims the benefit of Korean Patent Application Nos. 10-2005-0057661 and 10-2005-0057663, filed on Jun. 30, 2005, which are hereby incorporated by reference as if fully set forth herein.

### BACKGROUND OF THE INVENTION

1. Field of the Invention

The present invention relates to a home appliance, and more particularly, to a home appliance with an electronic album function which is capable of electronically constructing and displaying an album.

2. Discussion of the Related Art

Generally, a washing machine is an electric home appliance, which is most widely used in homes to remove contaminants attached to laundry such as clothes by utilizing a softening action of detergent, a frictional action of wash water flows resulting from a rotational action, an impact of the wash water flows applied to the laundry, etc.

For such washing machines, products of various washing types, for example, a pulsator type, agitator type, drum type, etc. are commercially available. Such washing machines may also be classified into a separation type and a full automation type in terms of whether or not washing and spin-drying tubs are separated from each other.

For most washing machines, the user uses the washing machines by properly setting washing conditions, such as a washing time, rinsing time and spin-drying time, according to the materials or amount of laundry.

A plurality of washing course programs are pre-stored in a memory so that they may be selectively utilized by the user to perform automatic washing for the user's convenience.

For example, a variety of washing course programs, such as centrifugal washing, high-concentration washing, prewashing, vibration washing, annealing washing and wool washing, may be pre-stored in the memory so that the user can simply and conveniently select a desired washing course to execute the automatic washing.

Besides, a drying machine is a home appliance which has a similar structure and is used in a similar manner.

Meanwhile, nowadays, customer concerns and desires for upgradation of home appliances are increasing. For this reason, in spite of the repeated development of home appliances for the user's convenience as mentioned above, it is next to impossible to expect that the customers will be satisfied with only the existing home appliances.

Recently, in a home appliance field, a multifunctionalization to integrate composite functions in one product is being attempted, as well as a high functionalization to improve the original function of the product.

These attempts are contrary evidence that the home appliance market has been saturated, but results of efforts to provide more excellent and convenient products through continuous technical development.

However, for a washing apparatus, such as a washing machine or drying machine, the user requires a higher technique than is currently possible, resulting in an increase in product cost of the washing apparatus and, in turn, a limitation in universal use thereof. In this regard, at present, there is a need for a new technique capable of readily acquiring various information even at low cost.

### SUMMARY OF THE INVENTION

Accordingly, the present invention is directed to a home appliance with an electronic album function that substantially obviates one or more problems due to limitations and disadvantages of the related art.

An object of the present invention is to provide a home appliance with an electronic album function which can be universally used at a lower cost.

Another object of the present invention is to provide a home appliance with an electronic album function which can significantly increase customer satisfaction with a multifunctionalization thereof.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a home appliance with an electronic album function comprises: a washing device for washing or drying clothes; and a monitor device fixedly mounted in a predetermined position of the washing device or detachably mounted thereto, the monitor device storing image data including photographs and moving images and displaying the stored image data in response to a request from a user.

Preferably, the monitor device comprises: an input/output terminal for inputting the image data including the photographs and moving images from external image capture means or storage media; a memory for storing the image data inputted through the input/output terminal; a monitor controller for encoding or decoding and outputting the image data stored in the memory in response to the request from the user; and an image output unit for displaying the image data outputted from the monitor controller.

Preferably, the input/output terminal is a universal serial bus (USB) port connectable with the image capture means or storage media, the image capture means or storage media outputting various image data in the form of digital image signals.

Alternatively, the input/output terminal may be an RS-232 communication port connectable with the image capture means or storage media, the image capture means or storage media outputting various image data in the form of digital image signals.

The home appliance may further comprise a remote controller for inputting control commands from the user to the washing device and monitor device.

Preferably, the remote controller comprises a key panel for control of the washing device, and a key panel for control of the monitor device, whereby the remote controller is used in common for the washing device and monitor device.

The washing device and the monitor device may be interconnected via a serial communication line so that they can perform data communication therebetween.

Preferably, the washing device comprises: a key input unit for inputting washing or drying mode conditions from the user; a load driver for driving loads necessary for a washing or drying mode; a display unit for displaying current mode conditions in progress and a current mode progress state; and a controller for controlling the mode according to the mode conditions inputted from the user.

The washing device may further comprise an Internet-connectable communication unit.

In another aspect of the present invention, a home appliance with an electronic album function comprises: a washing device for washing or drying clothes; and a monitor device for remotely controlling and monitoring an operation of the washing machine through communication with the washing device, the monitor device having the electronic album function to display image data including photographs and moving images in response to a request from a user.

Preferably, the monitor device comprises: a communication unit for transmitting a control command to the washing device or receiving state information of the washing device therefrom through power line communication with the washing device; an input/output terminal for inputting the image data including the photographs and moving images from external image capture means or storage media; a memory for storing the image data inputted through the input/output terminal; an image output unit for displaying the state information of the washing device received from the washing device and the image data stored in the memory; and a monitor controller for, in response to a control command from the user, processing the state information of the washing device and the image data stored in the memory in the form of image signals and outputting the resulting image signals to the image output unit.

Alternatively, the monitor device may comprise: a communication unit for transmitting a control command to the washing device or receiving state information of the washing device therefrom through power line communication with the washing device; an audio output unit for outputting the state information of the washing device received from the washing device in the form of an audio signal; an input/output terminal for inputting the image data including the photographs and moving images from external image capture means or storage media; a memory for storing the image data inputted through the input/output terminal; an image output unit for displaying the state information of the washing device received from the washing device and the image data stored in the memory; and a monitor controller for, in response to a control command from the user, processing the state information of the washing device in the form of an image or audio signal and outputting the resulting image or audio signal to the image output unit or audio output unit, and processing the image data stored in the memory in the form of an image signal and outputting the resulting image signal to the image output unit.

The communication unit may be a communication module which performs the power line communication.

The home appliance may further comprise a key input unit including a key panel for control of the washing device, and a key panel for control of the electronic album function.

The monitor controller may provide a graphic user interface (GUI) through the image output unit.

The aforementioned home appliance with the electronic album function according to the present invention has effects as follows.

Firstly, the electronic album function is provided in the home appliance, thereby significantly increasing customer satisfaction with a multifunctionalization of the home appliance.

Secondly, it is possible not only to monitor the progress state of the home appliance, but also to implement the electronic album function, through the monitor device of the home appliance. Therefore, a product can be used more universally.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 and FIG. 2 are perspective views showing a first embodiment of a home appliance with an electronic album function according to the present invention;

FIG. 3 is a block diagram showing the configurations of a monitor device and a washing machine body according to the first embodiment;

FIG. 4 is a perspective view showing a second embodiment of the home appliance with the electronic album function according to the present invention; and

FIG. 5 is a block diagram of a monitor device according to the second embodiment.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

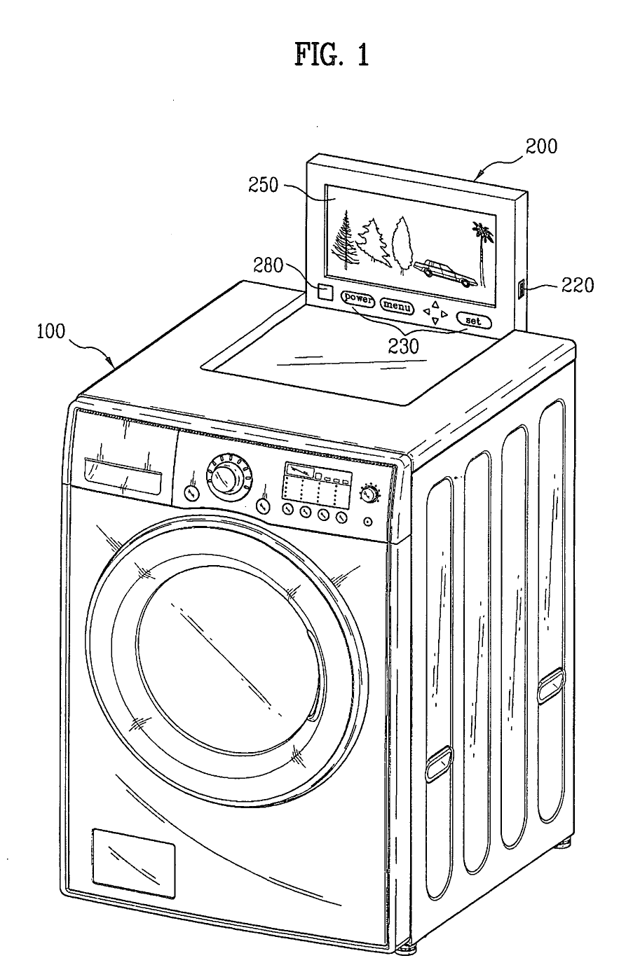

A first embodiment of a home appliance with an electronic album function according to the present invention will hereinafter be described with reference to FIG. 1 to FIG. 3.

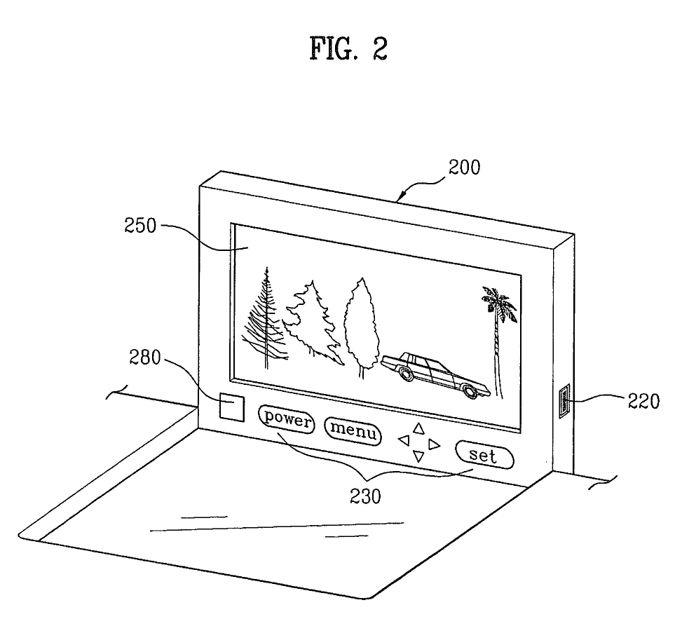

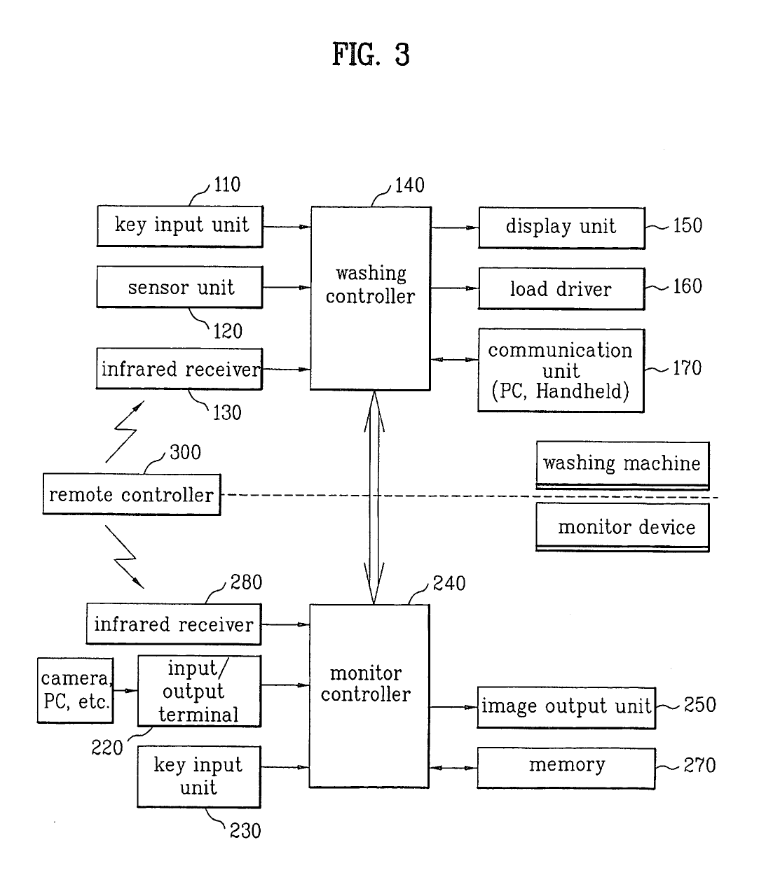

FIG. 1 and FIG. 2 are perspective views showing the first embodiment of the home appliance, for example, a washing machine, with the electronic album function according to the present invention, and FIG. 3 is a block diagram showing the configurations of a monitor device and a washing machine body according to the first embodiment.

The washing machine according to the first embodiment comprises a washing machine body 100 for performing a washing mode, and a monitor device 200 installed at a predetermined position of the washing machine body 100 integrally with the body 100 for displaying image data, such as a photograph and a moving image.

Referring to FIG. 3, the washing machine body 100 includes a key input unit 110 for inputting various washing mode conditions from the user, a sensor unit 120 for sensing various mode states, such as the amount of laundry, the level of wash water, the temperature of wash water and the rotation speed of a motor, required in the washing mode, a display unit 150 for displaying current mode conditions in progress and a current washing progress state, a load driver 160 for driving loads (a feed/drain valve, motor, etc.) necessary for the washing mode, and a washing controller 140 for controlling the entire operation of the washing mode according to the washing mode conditions inputted through the key input unit 110 and the mode states sensed by the sensor unit 120.

The washing machine body 100 further includes a communication unit 170 which is a personal terminal (a personal computer (PC), handheld device or the like) capable of performing Internet communication. The communication unit 170 enables the user to use, over the Internet, a variety of services including downloading washing course programs.

The monitor device 200 includes a key input unit 230 for inputting a control command for the electronic album function from the user, an input/output terminal 220 for inputting image data, such as a photograph and a moving image, from external image capture means or storage media, a memory 270 for storing the image data inputted through the input/output terminal 220, a monitor controller 240 for encoding or decoding and outputting the image data stored in the memory 270 in response to a request from the user, and an image output unit 250 for displaying the image data outputted from the monitor controller 240. The monitor device 200 is preferably used as an electronic album.

The monitor device 200 is contained in the side or top plate of a cabinet constituting the outer appearance of the washing machine body 100 in a folded manner, as shown in FIG. 1. Alternatively, the constituent elements of the monitor device 200, with the exception of the image output unit 250, may be installed inside of the washing machine in a hidden manner. Also, the monitor device 200 may be developed in such a detachable manner that it is kept separated from the washing machine at ordinary times and is fixed at a predetermined position of the washing machine to be used as needed, according to an option selected by the user.

The input/output terminal 220 is installed in the outer surface of the casing of the monitor device 200 to be exposed externally. This input/output terminal 220 includes a universal serial bus (USB) port or RS-232 communication port so that it is connectable with devices which digitize and output images, such as a computer, a digital camera, a scanner, a video camera, and a camera-embedded mobile phone.

The memory 270 is a storage medium capable of receiving and storing the image data inputted from the input/output terminal 220. This memory 270 may be, for example, a hard disk or ZIP disk which stores a digital image.

The monitor controller 240 encodes a digital image inputted through the input/output terminal 220 in a joint photographic experts group (JPEG) format to compress/store it in the memory 270, or decodes a digital image of a JPEG format stored in the memory 270 to output it to the image output unit 250. The monitor controller 240 may also convert the format of the inputted digital image into a moving picture experts group (MPEG) format for a moving image.

The key input unit 230 includes a key panel which is installed at a predetermined position of the outer surface of the casing of the monitor device 200 to enable the user to control various settings or image data to be outputted through the image output unit 250.

The washing machine according to this first embodiment further comprises a remote controller 300 for inputting control commands from the user to the washing machine body 100 and monitor device 200. A key panel for control of the washing machine body 100 and a key panel for control of the monitor device 200 are together provided in the remote controller 300 so that the remote controller 300 can be used for both the washing machine body 100 and monitor device 200.

That is, a key panel corresponding to the key input unit 110 of the washing machine body 100 and a key panel corresponding to the key input unit 230 of the monitor device 200 are together provided in the remote controller 300.

A code format of the washing machine body 100 and a code format of the monitor device 200 are together provided in the remote controller 300 so that the remote controller 300 can transmit a key code based on the corresponding code format of a key panel operated by the user.

The washing machine body 100 and the monitor device 200 further include infrared receivers 130 and 280, respectively. Each of the infrared receivers 130 and 280 acts to receive a key code transmitted from the remote controller 300.

With this configuration, the infrared receivers 130 and 280 receive key codes transmitted from the remote controller 300 and transfer the received key codes to the washing controller 140 and monitor controller 240, respectively. At this time, the washing controller 140 and monitor controller 240 recognize only key codes of the code formats corresponding thereto.

In view of control, the washing machine body 100 and the monitor device 200 can be configured to be controlled independent of each other.

Alternatively, the washing controller 140 and the monitor controller 240 may be interconnected via a serial communication line such that data communication is enabled between the washing machine body 100 and the monitor device 200.

A description will hereinafter be given of the operation of the first embodiment of the washing machine with the electronic album function according to the present invention, constructed as stated above.

First, in the washing machine body 100, the washing controller 140 controls the load driver 160 to drive loads necessary for the washing mode in consideration of washing mode conditions inputted by the user or mode states sensed by the sensor unit 120.

At this time, the washing controller 140 displays current mode conditions in progress or a current washing progress state through the display unit 150 of the washing machine body 100.

Further, the washing controller 140 transfers information regarding the current washing progress state to the monitor controller 240 through communication with the monitor controller 240.

Meanwhile, the monitor device 200 receives digital image data provided from various media, for example, a computer, digital camera, scanner, video camera, mobile phone, etc., through the input/output terminal 220, and stores the received image data in the memory 270.

Thereafter, according to the user's selection, the monitor controller 240 reads a corresponding one of the image data stored in the memory 270, converts the read image data into a signal that can be outputted, and outputs the converted signal through the image output unit 250.

At this time, according to the user's setting, a picture array effect may be provided in which a plurality of images stored in the memory 270 are slid at an interval of several seconds or several minutes.

On the other hand, if the washing progress state information from the washing controller 140 is received, the monitor controller 240 mixes image data currently displayed through the image output unit 250 with the received washing progress state information to output them together.

For example, provided in a display area of the image output unit 250 is a picture in picture (PIP) function which configures image data of the electronic album function as a main picture and the washing progress state information as a sub-picture.

Alternatively, a caption area may be provided under the display area of the image output unit 250 to display the washing progress state information in the form of a caption.

For the display of the washing progress state using the image output unit 250, the monitor controller 240 may successively display the washing progress state information by performing data communication with the washing machine body 100 in real time, or display the washing progress state information by performing the data communication with the washing machine body 100 only when there is a request from the user.

Therefore, according to the present first embodiment, the monitor device is installed in the washing machine to implement the electronic album function in the washing machine. Also, the washing progress state can be displayed through the image output unit of the monitor device.

On the other hand, recently, with the increase in the living space of a house, a washing machine or drying machine (referred to hereinafter only as a “washing machine”) is on a trend of being installed and used in a separate place distant from the living space, such as the outdoors or the basement of the house.

In the case where a washing machine is installed away from the living space like this, the user has to frequently visit a place where the washing machine is installed, to control the washing machine or monitor the operation state thereof, resulting in an inconvenience to the user.

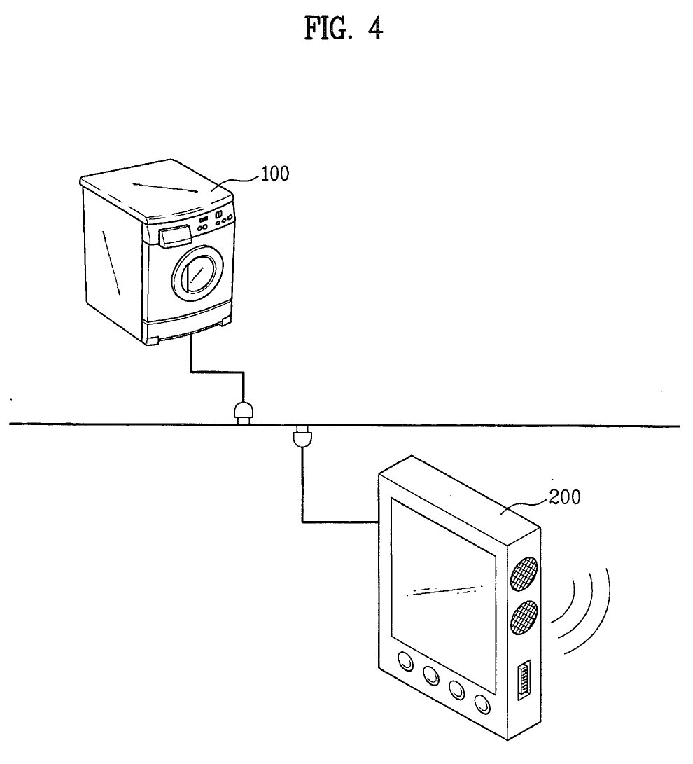

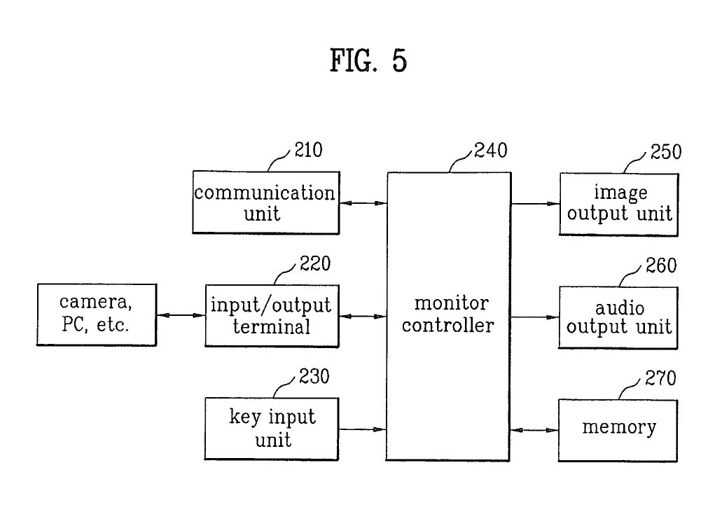

A second embodiment of the home appliance with the electronic album function according to the present invention will hereinafter be described with reference to FIG. 4 and FIG. 5.

FIG. 4 is a perspective view showing the second embodiment of the home appliance, for example, a washing machine, with the electronic album function according to the present invention, and FIG. 5 is a block diagram of a monitor device according to the second embodiment.

In the second embodiment, the washing machine body 100 is installed in a separate space, such as the outdoors or the basement of a house, to periodically transmit information regarding a current washing progress state through power line communication.

In contrast, the monitor device 200 is installed in the living space of the house such that it can be more readily used by the user at a shorter distance therefrom.

As a result, the monitor device 200 can not only remotely control the distant washing machine body 100 from within the house through the power line communication with the washing machine body 100, but also check the state information transmitted from the washing machine body 100 and output the washing progress state including washing mode conditions, the remaining mode time, mode errors, mode start/end, etc. in various forms (image or audio).

The present second embodiment is characterized in that the electronic album function is additionally provided in the monitor device 200 which is means for the remote control of the washing machine body 100.

To this end, the monitor device 200 includes a communication unit 210 for transmitting a control command to the washing machine body 100 or receiving state information of the washing machine body 100 therefrom through the power line communication with the washing machine body 1001 and an audio output unit 260 for outputting the state information of the washing machine body 100 received through the communication unit 210 in the form of an audio signal. The input/output terminal 220 acts to input image data, such as a photograph and a moving image, from external image capture means or storage media, and the memory 270 acts to store the image data inputted through the input/output terminal 220. The image output unit 250 functions to display the state information of the washing machine body 100 received through the communication unit 210 and the image data stored in the memory 270. The monitor controller 240 functions to, in response to a control command from the user, process the state information of the washing machine body 100 in the form of an image or audio signal and output the resulting image or audio signal to the image output unit 250 or audio output unit 260. The monitor controller 240 also functions to process the image data stored in the memory 270 in the form of an image signal and output the resulting image signal to the image output unit 250.

The communication unit 210 is a communication module capable of performing the power line communication, for example, a power line modem. This communication unit 210 can perform data communication with the washing machine body 100 without using a network such as a gateway or a communication network such as the Internet.

The monitor controller 240 is equipped with an application program to perform the electronic album function, as well as the data communication with the washing machine body 100.

The monitor device 200 includes the audio output unit 260 to output the state information of the washing machine body in the form of an audio signal. The audio output unit 260 is installed in the side or front plate of a cabinet constituting the outer appearance of the monitor device 200.

The image output unit 250 includes a liquid crystal display (LCD) to display the state information of the washing machine body 100 and the image data stored in the memory 270.

The key input unit 230 is adapted to receive a control command signal based on a key operation of the user and transfer it to the monitor controller 240. A key panel for washing-associated control and a key panel for control of the electronic album function are together provided in the key input unit 230.

In order to remotely control the monitor device 200, a remote controller (not shown) may be provided which has the same key panels as those of the key input unit 230.

The input/output terminal 220 is installed in the cabinet side to be exposed externally. This input/output terminal 220 includes a USB port or RS-232 communication port so that it is connectable with devices which digitize and output images, such as a computer, a digital camera, a scanner, a video camera, and a camera-embedded mobile phone.

The memory 270 is a storage medium capable of receiving and storing the image data inputted from the input/output terminal 220. This memory 270 may be, for example, a hard disk or auxiliary memory unit such as a ZIP disk which stores a digital image.

The monitor controller 240 encodes a digital image inputted through the input/output terminal 220 in a JPEG format to compress/store it in the memory 270, or decodes a digital image of a JPEG format stored in the memory 270 to output it to the image output unit 250. The monitor controller 240 may also convert the format of the inputted digital image into an MPEG format for a moving image.

A description will hereinafter be given of the operation of the second embodiment of the washing machine with the electronic album function according to the present invention, constructed as stated above.

First, if the user connects a medium, such as a computer, digital camera, video camera or mobile phone, to the input/output terminal 220 of the monitor device 200, the monitor controller 240 performs data communication with the connected medium according to the application program installed therein.

At this time, the monitor controller 240 provides a graphic user interface (GUI) through the image output unit 250. The user selects image data to be loaded to the monitor device 200 by operating the key input unit 230 while viewing the GUI displayed through the image output unit 250.

Then, image data uploaded from the medium connected to the input/output terminal 220 is stored in the memory 270 under the control of the monitor controller 240.

If the user selects image data to be displayed on the monitor device 200 after executing the electronic album-associated GUI, the monitor controller 240 reads the selected image data from the memory 270.

Subsequently, the monitor controller 240 converts the image data read from the memory 270 into a signal that can be outputted, and outputs the converted signal to the image output unit 250.

At this time, the user may select a plurality of images to be displayed through the image output unit 250 of the monitor device 200. In this case, a picture array effect may be provided in which the selected images are slid at an interval of several seconds or several minutes.

Meanwhile, if the state information of the washing machine body 100 is received through the communication unit 210, the monitor controller 240 mixes image data currently displayed through the image output unit 250 with the received state information to output them together.

For example, provided in a display area of the image output unit 250 is a picture in picture (PIP) function which configures image data of the electronic album function as a main picture and the washing machine body state information as a sub-picture.

Alternatively, a caption area may be provided under the display area of the image output unit 250 to display the washing machine body state information in the form of a caption.

For the display of the washing machine body state using the image output unit 250, the monitor controller 240 may successively display the washing machine body state information by performing the data communication with the washing machine body 100 in real time, or display the washing machine body state information by performing the data communication with the washing machine body 100 only when there is a request from the user.

On the other hand, in the case where the state information received from the washing machine body 100 is an audio signal, it is outputted through the audio output unit 260 under the control of the monitor controller 240.

For example, when a mode error, such as eccentricity, occurs in the washing machine body 100 or the washing mode is ended, the resulting signal is transmitted to the monitor controller 240 and then outputted through the audio output unit 260 in the form of a voice error message or buzzer sound under the control of the monitor controller 240.

Therefore, according to the present second embodiment, the electronic album function is additionally provided in the monitor device which remotely controls the washing machine. Therefore, it is possible to implement the electronic album function for digital images through the monitor device.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A home appliance with an electronic album function comprising:
a washing device for washing or drying clothes; and
a monitor device fixedly mounted in a predetermined position of the washing device or detachably mounted thereto, the monitor device storing image data including photographs and moving images and displaying the stored image data in response to a request from a user.

2. The home appliance according to claim 1, wherein the monitor device comprises:
an input/output terminal for inputting the image data including the photographs and moving images from external image capture means or storage media;
a memory for storing the image data inputted through the input/output terminal;
a monitor controller for encoding or decoding and outputting the image data stored in the memory in response to the request from the user; and
an image output unit for displaying the image data outputted from the monitor controller.

3. The home appliance according to claim 2, wherein the input/output terminal is a universal serial bus (USB) port connectable with the image capture means or storage media, the image capture means or storage media outputting various image data in the form of digital image signals.

4. The home appliance according to claim 2, wherein the input/output terminal is an RS-232 communication port connectable with the image capture means or storage media, the image capture means or storage media outputting various image data in the form of digital image signals.

5. The home appliance according to claim 1, further comprising a remote controller for inputting control commands from the user to the washing device and monitor device.

6. The home appliance according to claim 5, wherein the remote controller comprises a key panel for control of the washing device, and a key panel for control of the monitor device, whereby the remote controller is used in common for the washing device and monitor device.

7. The home appliance according to claim 1, wherein the washing device and the monitor device are interconnected via a serial communication line so that they can perform data communication therebetween.

8. The home appliance according to claim 1, wherein the washing device comprises:
a key input unit for inputting washing or drying mode conditions from the user;
a load driver for driving loads necessary for a washing or drying mode;
a display unit for displaying current mode conditions in progress and a current mode progress state; and
a controller for controlling the mode according to the mode conditions inputted from the user.

9. The home appliance according to claim 8, wherein the washing device further comprises an Internet-connectable communication unit.

10. A home appliance with an electronic album function comprising:
a washing device for washing or drying clothes; and
a monitor device for remotely controlling and monitoring an operation of the washing machine through communication with the washing device, the monitor device having the electronic album function to display image data including photographs and moving images in response to a request from a user.

11. The home appliance according to claim 10, wherein the monitor device comprises:
a communication unit for transmitting a control command to the washing device or receiving state information of the washing device therefrom through power line communication with the washing device;
an input/output terminal for inputting the image data including the photographs and moving images from external image capture means or storage media;
a memory for storing the image data inputted through the input/output terminal;
an image output unit for displaying the state information of the washing device received from the washing device and the image data stored in the memory; and
a monitor controller for, in response to a control command from the user, processing the state information of the washing device and the image data stored in the memory in the form of image signals and outputting the resulting image signals to the image output unit.

12. The home appliance according to claim 10, wherein the monitor device comprises:
a communication unit for transmitting a control command to the washing device or receiving state information of the washing device therefrom through power line communication with the washing device;
an audio output unit for outputting the state information of the washing device received from the washing device in the form of an audio signal;
an input/output terminal for inputting the image data including the photographs and moving images from external image capture means or storage media;
a memory for storing the image data inputted through the input/output terminal;
an image output unit for displaying the state information of the washing device received from the washing device and the image data stored in the memory; and
a monitor controller for, in response to a control command from the user, processing the state information of the washing device in the form of an image or audio signal and outputting the resulting image or audio signal to the image output unit or audio output unit, and processing the image data stored in the memory in the form of an image signal and outputting the resulting image signal to the image output unit.

13. The home appliance according to claim 11 or 12, wherein the communication unit is a communication module which performs the power line communication.

14. The home appliance according to claim 13, wherein the input/output terminal is a USB port connectable with the image capture means or storage media, the image capture means or storage media outputting various image data in the form of digital image signals.

15. The home appliance according to claim 13, wherein the input/output terminal is an RS-232 communication port connectable with the image capture means or storage media, the image capture means or storage media outputting various image data in the form of digital image signals.

16. The home appliance according to claim 13, further comprising a key input unit including a key panel for control of the washing device, and a key panel for control of the electronic album function.

17. The home appliance according to claim 13, further comprising a remote controller including a key panel for control of the washing device, and a key panel for control of the electronic album function.

18. The home appliance according to claim 13, where the monitor controller provides a graphic user interface through the image output unit.
